(19) United States
(12) Patent Application Publication
(10) Pub. No.: US 2005/0279024 A1
(43) Pub. Date: Dec. 22, 2005

(54) Deflection roller installation

(76) Inventors: Harald Koellner, Altenstadt (DE); Enrico Schliwa, Lauderdan (DE); Thomas Schmelz, Niestetal (DE)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/519,908

(22) PCT Filed: Jul. 1, 2003
(86) PCT No.: PCT/EP03/06996

§ 371 Date: Jul. 5, 2005

(30) Foreign Application Priority Data
Jul. 1, 2002 (DE) 202 10 370.6

(51) Int. Cl. E05F 11/48

(52) U.S. Cl. 49/352

(57) ABSTRACT

A deflection roller installation fastening a deflection roller for a rope used for driving a motor vehicle window pane. Deflection rollers are rotatably mounted on a window-lifting rail used for guiding the pane. The window-lifting rail is provided with an outward formation for receiving the deflection rollers. A module support couples the window-lifting rail to a portion of a vehicle door, the module support including a peg engaging the outward formation.

The present invention relates to a deflection roller installation according to the preamble of claim 1.

Deflection roller installations for fastening a deflection roller for a cable for the drive of a motor vehicle windowpane, in particular a lateral windowpane of a motor vehicle arranged between the A and B-column. According to the state of the art the deflection rollers are usually attached on a window-lifting rail. This window-lifting rail on the one hand serves for guiding the windowpane, e.g. chiefly in the perpendicular direction. On the other hand the window-lifting rail over a large area also supports the windowpane, by which means its protective function for the windowpane is accomplished. The deflection rollers are designed for guiding a cable which effects the lifting and lowering of the windowpane.

The window-lifting rails according to the state of the art are of e.g. 3 mm thick sheet metal. The thickness of the sheet metal is dictated by a certain minimum thickness for ensuring the guiding and protective function of the cantilever window-lifting rail.

The fastening of the deflection roller on the window-lifting rail according to the state of the art is designed as a rivet which serves as an arbor and furthermore serves as an axial fastening of the deflection roller.

Proceeding from this state of the art it is the object of the present invention to provide a deflection roller installation which reduces the material application and thus the complexity of the deflection roller installation, and on the other hand permits a secure and permanent retention of the deflection roller.

This object is achieved by a deflection roller installation according to claim 1.

By way of the fact that the window-lifting rail has an outward formation for mounting the deflection roller, now the deflection roller may be mounted directly on this outward formation. It is no longer necessary for separate arbor components, such as e.g. rivets etc. to be provided for mounting the deflection roller. This is due to the fact that surprisingly, it has been shown that the window-lifting rails which in earlier years were relatively thick may also be manufactured of thinner or stronger sheet metals (metal plate) so that in a simple manner one may realise an integration of an outward formation for mounting the deflection roller.

Advantages of this design are the reduced complexity as well as a reduction of weight and costs on manufacture, and also a reduction of the error expense on assembly. Furthermore, it is relatively simple with an injection (moulding) procedure or a push-through procedure for manufacturing the outward formation to achieve a large diameter of the outward formation and thus of the arbor of the deflection roller. By way of this there results an even further improved stability of the deflection roller with respect to the bending moments which engage here.

Advantageous further designs of the present invention are specified in the dependent claims

One advantageous embodiment envisages the outward formation to be a push-through of the window-lifting rail. For this the window-lifting rail is preferably manufactured of a 0.9 to 1.5 mm thick sheet metal, preferably of steel or aluminium. It is thus possible in a very simple manner to carry out the outward formation in a deep-drawing method etc. in single step or also multi-step method. This may be effected together with the other shaping procedures of the window-lifting rail. Alternatively it is of course also possible to manufacture the window-lifting rail or the outward formation with an injection moulding method.

At the same time it is moreover favourable to carry out the outward formation in the region of the mounting in an essentially circularly cylindrical manner in order thus to mount a deflection roller e.g. of POM on this.

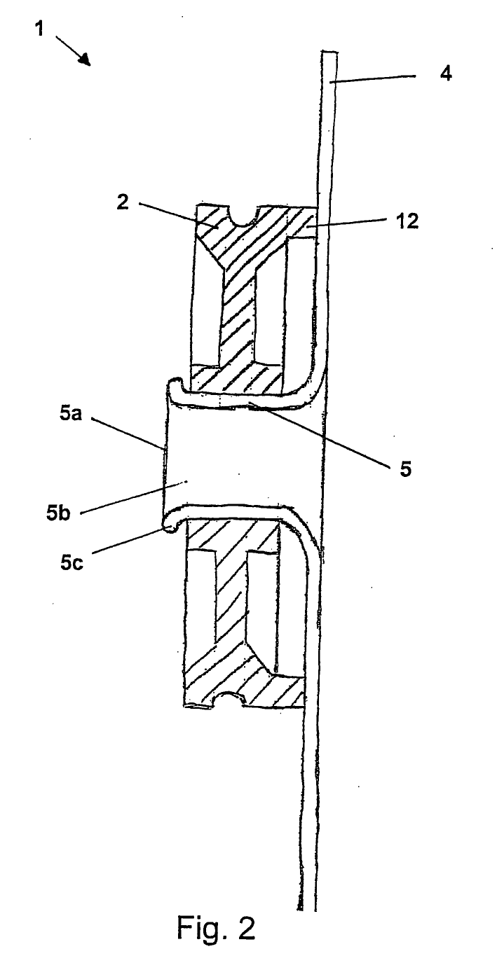

It is particularly advantageous for the outward formation on the end-face distant to the remaining window-lifting rail to comprise an opening. This with, the manufacture of the outward formation in a deep-drawing method may be effected by way of drilling an opening after the deep-drawing. In this manner it is also possible for the outward formation on the end-face, thus in the region of the opening, to comprise a widening for engaging behind and axially fixing the deflection roller. This may e.g. by effected by a beading which thus axially fixes one side of the deflection roller. It is possible on the other side of the deflection roller to provide a peripheral web, preferably in the outer radius region of the deflection roller, said web axially supporting the deflection roller on the other side (see e.g. FIG. 2) so that as a whole a defined mounting of the deflection roller is given.

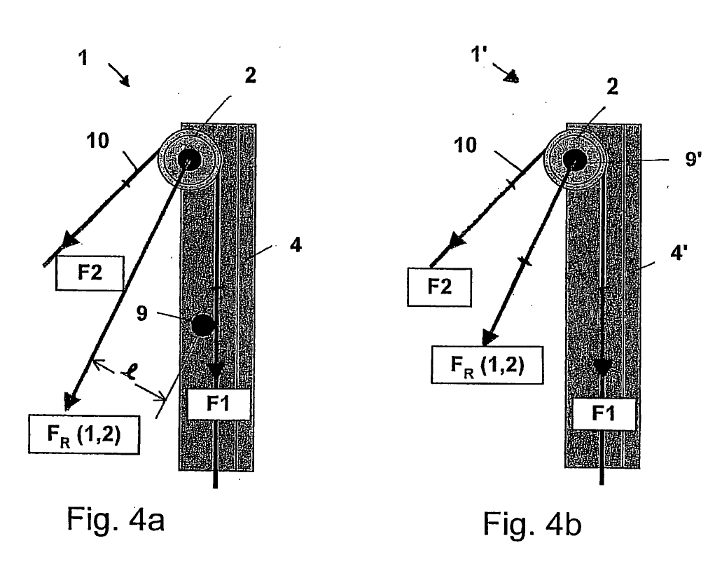

A further advantageous embodiment envisages the window-lifting rail to be fastened on the module support which e.g. is manufactured of plastic and is fastened on a door panel of a vehicle door or on a door frame of a vehicle door. At the same time it has been shown to be advantageous for a peg which centres or fixes the window-lifting rail with respect to the module support to engage into the recess with a positive fit. Thus the peg provided in the module support achieves the exact positioning of the deflection roller with respect to the module support. The peg is thus the “theoretical zero point”, also for the roller. By way of this there is one element less in the tolerance chain. Furthermore such an arrangement is advantageous with regard to the forces acting on the deflection roller which may effect a bending or torsion of the window-lifting rail. This lies in the fact that the resulting force of the cable forces do not act with a lever [arm] with regard to the fastening point of the window-lifting rail, but directly on this fastening point (see both of FIGS. 4a and 4b).

It is furthermore possible for the peg of the module support (or e.g. a peg fastened on the door inner panel to also be used for axially fixing the window-lifting rail or the deflection roller (for this e.g. circlips are to be attached at the free end of the peg.

Further advantageous further designs of the present invention are specified in the remaining dependent claims.

The present invention is now explained by way of several Figures. There are shown in:

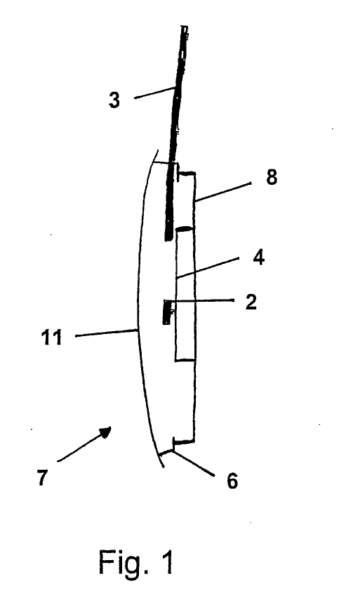

FIG. 1 the schematic construction of a vehicle door in cross section;

FIG. 2 the first embodiment of a deflection roller installation according to the invention;

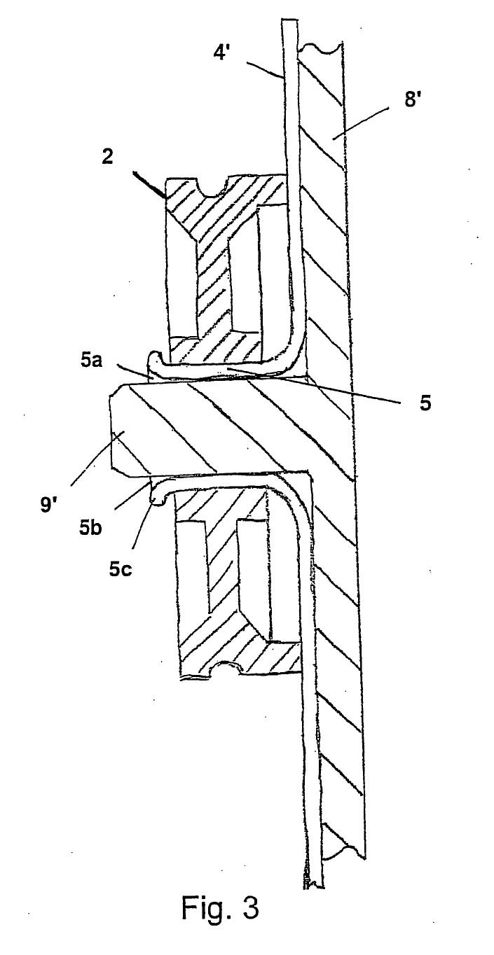

FIG. 3 a second embodiment of a deflection roller installation according to the invention;

FIGS. 4a and 4b a schematic representation of the force conditions on various embodiments of a deflection roller installation.

FIG. 1 shows the cross section of a vehicle door 7. This comprises an outer panel 11 to which an inner panel 6 is attached. A door module 8 is fastened on this inner plate. This door module is preferably manufactured of plastic and serves e.g. for the fastening of elements such as load speakers, locking elements etc. An interior trim which is not illustrated here is attached on that side of the door module 8 which is distant to the outer plate 11.

Furthermore a window-lifting rail 4 is attached on the door module 8. This window-lifting rail 4 serves primarily for guiding a windowpane 3. The drive of the windowpane 3 may be effected manually or electrically. The transmission of the drive of the windowpane 3 is effected e.g. via a cable drive which here is not shown. A cable for the drive of the windowpane 3 is led around a deflection roller 2 which is rotatably mounted on the window-lifting rail 4.

The invention is now explained in more detail according to this general arrangement.

FIG. 2 shows a cut-out of a window-lifting rail 4. This window-lifting rail 4 is formed from steel sheet which may have a thickness between 0.9 and 1.5 mm. It is however also possible to provide such window-lifting rails of aluminium.

The window-lifting rail 4 comprises an outward formation 5 which is manufactured in a deep-drawing method. This outward formation 5 in its middle region has an essentially circularly cylindrical cross section. A deflection roller 2 is rotatably mounted on this circularly cylindrical section. This deflection roller is manufactured as one piece from POM (polyoxymethylane). The outward formation 5 at its end face 5a which is distant from the remaining window-lifting rail has an opening 5b. A flanging 5c is provided in the region of this opening and this flanging axially fixes the deflection roller 2. The deflection roller in the axial direction on the other side of this, in the region of its outer periphery comprises a peripheral projection 12 which axially grazes the window-lifting rail 4.

Thus here it is the case of a deflection roller installation 1 for fastening a deflection roller 2 for a cable 10 which is not shown here (see FIGS. 4a and 4b). The deflection roller 2 is attached to the window-lifting rail 4 for guiding the windowpane 3 (see FIG. 1). The window-lifting rail 4 comprises the outward formation 5 for mounting the deflection roller 2.

In the following a further embodiment of the deflection roller according to the invention is show by way of FIG. 3. This differs only by way of an additional peg arrangement for fixing the outward formation. Inasmuch as nothing is expressed to the contrary, all those explanations made above with regard to FIGS. 1 and 2 also apply to this embodiment.

FIG. 3 shows a module support 8′ with a peg 9′ protruding in the direction of the window-lifting rail 4′. The module support 8′ is shown in its general arrangement in FIG. 1.

The window-lifting rail 4′ with recess 5 as well as deflection roller 2 corresponds completely to the arrangement of FIG. 2, with the exception that the fixation/centring of the window-lifting rail 4′ is effected in a different manner to that of the window-lifting rail 4 (with regard to this see both FIGS. 4a and 4b). Otherwise the recess 5, the opening 5b, the widening 5c etc. are exactly as in FIG. 2.

With the deflection roller installation 1′ of FIG. 3 however additionally a peg 9′ of the module support 8′ is provided which engages into the outward formation 5 in a complementary manner. By way of this, on the one hand a fastening of the window-lifting rail 4′ is achieved and furthermore a fixing of the deflection roller 2 with respect to the module support is achieved. The fixing of the location of the deflection roller 2 with respect to the module support 8′ has the advantage that by way of this the tolerance chain may be kept short.

It is also possible to provide an axial ring which is not shown here in the drawing, which abuts on the widening 5c and thus fixes the window-lifting rail 4′ on the module support 8′.

FIGS. 4a and 4b show a schematic representation of the force conditions of the deflection installation 1 or 1′ according to the invention.

The deflection roller 1 is shown in FIG. 4a. Here the window-lifting rail 4 fixes the deflection roller 2 about which a cable 10 is wound. The window-lifting rail 4 is fastened via a peg 9 onto a module support which is not illustrated here. The cable forces F1 and F2 engage on the deflection roller 2 and in the region of the arbor of the deflection roller (thus of an outward formation of the window-lifting rail 4) are introduced into the window-lifting rail. The resulting force F_{R} (1, 2) thus engages with a lever [arm] on the peg 9. A bending moment is exerted onto the window-lifting rail by way of this, so that this rail may be slightly distorted.

FIG. 4b shows a schematic illustration of the forces for a deflection installation 1′. Here as is shown in FIG. 3, an outward formation which forms the bearing arbor of the deflection roller 2 is attached with a positive fit on a peg 9′ of a module support which is not shown here. The resulting force of the forces F1 and F2, i.e. the force F_{R} (1, 2) again engages at the centre of the deflection roller 2. Since here the peg 9′ which is part of the module support is located here, the force F_{R} (1, 2) is now introduced directly into the module support. An additional bending moment as in FIG. 4a which could deform the window-lifting rail and thus could compromise the protective and guide function of the window-lifting rail does not occur.

Of course it would also be possible to attach the outward formation on which the deflection roller 2 is mounted on a peg, which e.g. is a part of the door inner panel or of the door frame (for example with doors which have no module support).

The present invention has great advantages in large-scale manufacture. To the first extent this is given by the relatively simple manner of manufacturing which makes do with only very few components. Thus it is possible in a simple manner on manufacture of the window-lifting rail for the outward formation (e.g. “in one step” with the rest of the window-lifting rail) to be manufactured with a deep-drawing method and after placing the deflection roller onto the outward formation, for a widening of the outward formation to be effected for engaging behind and axially fixing the deflection rollers. It is therefore not absolutely necessary to provide an additional component for axially fixing the deflection roller. Of course it is however also possible to ensure the axial fixation instead e.g. by way of a flanging, by way of placing on a fastening element for axially fixing the deflection roller.

A further significant advantage of the invention lies in the fact that the outward formation manufactured e.g. by way of deep-drawing simultaneously forms the accommodation for a peg of a module support. This peg may be integrally manufactured with the module support, such as integrally manufactured in an injection moulding method as a protruding peg. Here with regard to tolerances, it is also possible to fix the arbor of the deflection roller with respect to the door module due to the omission of a separate arbor which could produce additional tolerance fluctuations. Thus the tolerance chain is shortened and the quality with regard to tolerance fluctuations is improved alone on account if the design

In a further embodiment it may be possible, such as with door modules which practical integrally contain the window-lifting rail, to manufacture the outward formation also at the same time as an integral part of the module support such as with the injection moulding method.

In any case the deflection roller installation according to the present invention is characterised by a weight saving which is primarily achieved due to the fact that no additional parts are necessary for mounting or fixation.

1.-13. (canceled)

14. A deflection roller installation for fastening a deflection roller for a cable of a drive mechanism of a motor vehicle windowpane, comprising a window-lifting rail for guiding the windowpane, the rail having an outward formation for receiving the deflection roller, and a module support coupled to the window-lifting rail and coupled to a portion of a vehicle door, the module support including a peg engaging the outward formation.

15. A deflection roller installation according to claim 14, wherein the outward formation comprises a push-through of the window-lifting rail.

16. A deflection roller installation according to claim 14, wherein a region of the outward formation receiving the deflection roller consists essentially of a circularly cylindrical formation.

17. A deflection roller installation according to claim 14 wherein an end-face of the outward formation distant from the window-lifting rail comprises an opening.

18. A deflection roller installation according to claim 17, wherein the end-face of the outward formation distant from the window-lifting rail comprises a widening for engaging behind and axially fixing the deflection roller.

19. A deflection roller installation according to claim 14, further comprising a fastening element axially fixing the outward formation on the peg.

20. A deflection roller installation according to claim 14, wherein the window-lifting rail consists essentially of 0.9-1.5 mm thick sheet metal.

21. A deflection roller installation according to claim 20, wherein the window-lifting rail (4) is composed essentially of steel or aluminium.

22. A deflection roller installation according to claim 21, wherein the deflection roller is composed essentially of POM.

23. A method for manufacturing a deflection roller installation comprising the steps of: providing a window-lifting rail, forming an outward formation to receive the deflection roller using a deep-drawing method, placing the deflection roller onto the outward formation, and widening the outward formation to engage behind the deflection roller for axially fixing the deflection roller to the window-lifting rail.

24. A method according to claim 23, wherein the widening of the outward formation is effected by flanging for axially fixing the deflection roller.

25. A method according to claim 23, wherein the widening of the outward formation is effected by placing on a fastening element for axially fixing the deflection roller.
